(19) United States
(12) Patent Application Publication
(10) Pub. No.: US 2013/0118322 A1
(43) Pub. Date: May 16, 2013

(54) QUICK CHANGE TOOL

(71) Applicants: Brett P. Seber, Vista, CA (US); Wesley James Tom, Vista, CA (US)

(72) Inventors: Brett P. Seber, Vista, CA (US); Wesley James Tom, Vista, CA (US)

(21) Appl. No.: 13/295,949

(22) Filed: Nov. 14, 2011

(51) Int. Cl. B25B 23/00; B23P 17/04; B25B 15/00

(52) U.S. Cl. 81/440; 29/401.1

(57) ABSTRACT

A quick change tool and the method for using it are disclosed. The tool is configured to enable a user to select between multiple head types within the same tool without the need to physically remove the head from the hand tool. The tool may comprise a work member having more than one head configuration thereon, which is rotatably coupled to a shaft, and a sleeve that is axially movable relative to the shaft. As the sleeve is moved axially relative to the shaft, a biasing member on the sleeve engages the work member causing it to be rotated upon the shaft to alternatively position one or the other of at least two functional heads of the work member to be placed into a working position of the tool.

### BACKGROUND OF THE INVENTION

1. Field of the Invention

The present invention relates to hand tools, more particularly to hand tools having a functional head formed to function as a screw driver, a socket driver, a pick, or the like and more specifically to a hand tool having more than one such functional head thereon, wherein the functional heads may be interchanged between a working position and a storage position without the requirement of removing the functional head from the tool.

2. Description of the Related Art

Hand tools generally include one work member that allows a user to engage the tool for one particular use. For example, a hand tool may comprise a screwdriver, having a particular driver or head forming the work member thereon, such as a Phillips head, a flat head or a socket driver head. It is also known to provide a hand tool having interchangeable heads for different functions, wherein a user is faced with a cumbersome process of manually switching out the heads in order to fully utilize the interchangeability feature of the tool. Moreover, when using such a tool, there is a common problem of misplacing, or losing the interchangeable heads, even where the tool itself provides storage for such heads, such as in the handle thereof. Thus, the tool having interchangeable heads becomes, over time, a tool with a dedicated head and thus dedicated function, once all but one of the heads is lost, and, if the last of the interchangeable heads is lost, trash. There is a need for a tool that offers multiple functional heads within one hand tool, wherein the heads are quickly and easily interchanged, but the heads will not become lost or misplaced from the tool.

### SUMMARY OF THE INVENTION

A hand tool with a work member with multiple heads that can be easily and quickly interchanged is disclosed. The tool may comprise a work member having more than one head configuration thereon, which is rotatably coupled to a shaft, and a sleeve that is axially movable relative to the shaft. As the sleeve is moved axially relative to the shaft, a biasing member on the sleeve engages the work member causing it to be rotated upon the shaft to alternatively position one or the other of at least two functional heads of the work member to be placed into a working position of the tool.

A method of using a hand tool with a work member with multiple heads is also disclosed. To change the position of the heads within the tool, a sleeve located over a shaft is moved in one axial direction relative to the shaft, which biases the work member which causes rotation of the work member which is rotationally coupled to the shaft. The sleeve is then moved in a second axial direction relative to the shaft, which completes rotation of the work member within the shaft to align the second end of the work member to be received within the sleeve as the sleeve continues to move in the second direction, and thereby changes the functional head of the tool from a first head type to a second head type.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective view of a quick change tool with a work member, having two different head structures at opposed ends thereof, in a first working position wherein the first of the two opposed heads is positioned for use by a tool user;

FIG. 2 is a perspective view of the tool with the work member in transition between the first working position and a second working position

FIG. 3 is a perspective view of the tool with the work member in the second working position such that the second of the two heads is positioned for use by a tool user;

FIG. 4 is an exploded view of the tool;

FIG. 5 is a cutaway view of the tool in the first working position, wherein a first head of the tool is positioned for use by a tool user;

FIG. 6 is a cutaway view of the tool wherein a sleeve is positioned a first distance from the tool handle such that a biasing member engages the work member at a position within the sleeve;

FIG. 7 is a cutaway view of the tool, wherein the sleeve is positioned a second distance from the handle of the tool such that the work member can rotate through a clearance slot in the sleeve;

FIG. 8 is a cutaway view of the tool wherein the sleeve is positioned at its furthest extension from the handle and the biasing member has caused the work member to rotate and position opposed ends of the work member to extend through opposed clearance slots in the sleeve;

FIG. 9 is a cutaway view of the tool wherein the sleeve has been moved axially toward the handle from the sleeve position of FIG. 8 such that a shim has made contact against the work member; and

FIG. 10 is a cutaway view of the tool wherein the sleeve has been repositioned to its original position of FIG. 5, but a second head of the work member is positioned in the working position of the tool.

### DETAILED DESCRIPTION

The hand tool 5 of the present invention is configured to enable a user to select between multiple head types within the same tool without the need to physically remove the head from the hand tool 5. The tool includes a work member 10 having opposed tool heads 26, 28 thereon, and a sleeve 60 and shaft 30 arrangement whereby the reciprocal sliding of the sleeve 60 along the shaft 30 causes the position of tool heads 26, 28 to be interchanged within the tool 5. In the embodiment shown and described herein, this is accomplished by supporting the work member 10 on a pin 20 which spans a clearance gap 11 in the shaft, and the sleeve 60 includes clearance slots 65A, B therein through which the ends of the work member 10, having the tool heads 26, 28 positioned thereon, may pass during interchange of the heads, and a biasing member 70 which causes the work member 10 to pivot on the pin 20 in response to movement of the sleeve 60 with respect to the shaft 30. When the sleeve 60 in moved in a direction away from the handle 80, along the shaft 30 which is secured within the handle 80, the biasing member 70 becomes positioned to engage an end of the work member 10 located or stored within the clearance gap 11 in the shaft 30, and as the sleeve 60 continues to move further along the shaft 30 in the same direction, the opposed end of the work member 10, which has been retracted from a working position by the movement of the sleeve 60 with respect to the shaft 30, is free to swing or pass through the slots 65A, B, and the force exerted by the biasing member 70 causes the work member 10 to rotate on the pin 20, causing the opposed ends thereof to pass through the opposed clearance slots 65A, B. The two clearance slots have different lengths of extension along the sleeve as measured from the handle, such that the end of slot 65A spaced from the handle, or a secondary feature thereon, will engage the shank or side of the work member 10 extending there through as the sleeve 60 is moved in the direction of the handle 80, thereby causing continued rotation of the work member 10 about the shaft 20 to position the previously stored end of the work member into a working position of the tool 5, and the end of the work member 10 which was previously position for use with the tool into a storage position within the clearance gap 11. Thus, the tool user need not locate and load different tool heads into the tool 5 to choose between tool heads. The tool user may simply choose which of the heads 26, 28 provided on the opposed ends of the work member 10 to employ with the tool 5, and merely slide the sleeve 60 back and forth on the shaft 30 in order to employ the particular tool head 26, 28.

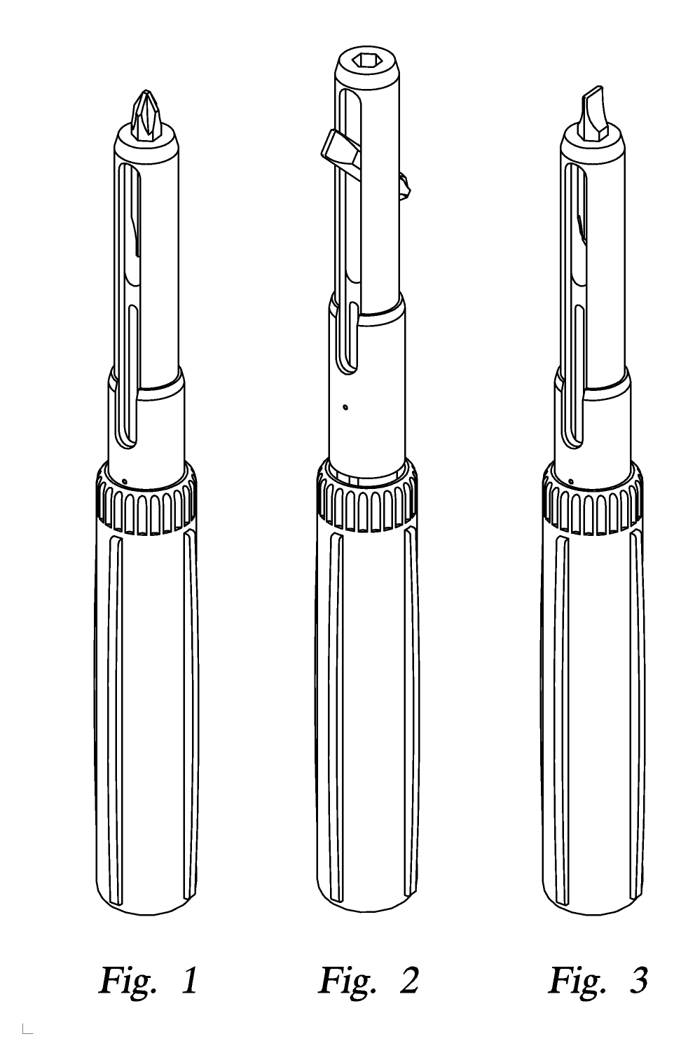

An overview of an embodiment of the present invention is indicated in FIGS. 1-3. In FIG. 1, a quick change tool 5 is shown with its work member 10 in a first working position 100 such that a first head 26 of the work member is positioned for use with the tool 5. To use the tool 5, a user grips the handle 80 and places the first head 26 of the tool 5, which, as depicted in this embodiment is a Phillips head screwdriver tip, within the head of a Phillips screw (not shown). The user may hold the handle 80 to support the tool 5 in the screw and rotate the handle with the hand, and thus proceed to drive the screw inwardly or outwardly into a member as desired.

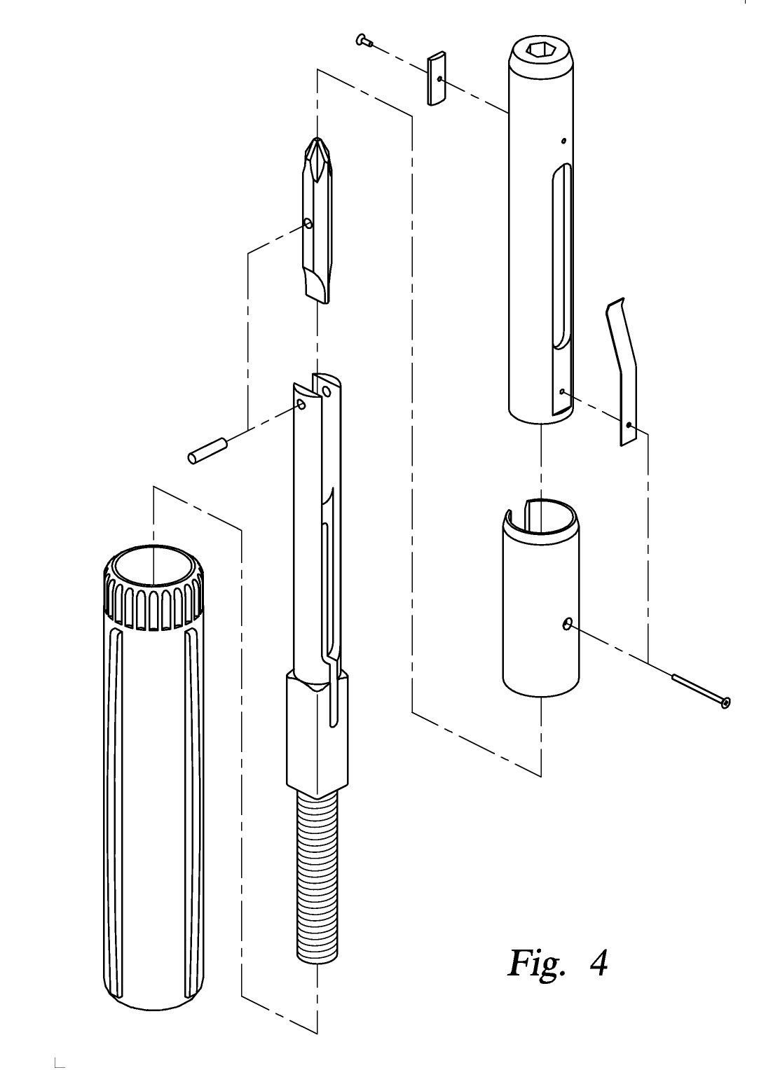

The sequence of steps to change the tool head configuration between a first head and second head is shown generally in FIGS. 2 and 3 wherein by moving the sleeve 60 axially over a shaft 30, the work member 10 spins or rotates on the shaft (via pin 20 in FIG. 4) to enable interchanging of the opposed working heads, disposed on opposed ends of the work member 10, for use with the tool 5. In FIG. 2, the tool 5 is shown with the work member 10 in transition between the first working position 100 (as shown in FIG. 1) and a second working position 200 (as shown in FIG. 3). The sleeve 60 and the outer sleeve 50 (which are attached via a biasing member fastener 72 shown in FIG. 4) have been moved from the position in FIG. 1 to a position spaced away from the handle 80, which allows clearance slots 65 in the sleeve 60 to be positioned to allow the opposed ends of the work member 10 to pass through as the work member 10 is rotated on the shaft 30. The rotation of the work member 10 on the shaft 30 enables the interchanging of the first and second heads 26, 28 of the work member 10. In FIG. 3, the user of the tool 5 has positioned the sleeve 50 and outer sleeve 50 back into its original position, as was shown in FIG. 1, on the handle 80, and the work member 10 has been rotated 180 degrees about the pin 20 into the second working position 200. In this position, the second head 28 of the work member 10 is positioned for use with the tool 5. The tool 5 is thus usable in either working position, but different ends of the work member 10, having different configurations, may be positioned in the working position without the work member 10 being detached from the tool 5.

FIG. 4 is an exploded view of the tool 5 showing the configuration and assembly of the tool 5 components. The tool 5 generally includes the shaft 30 partially received in, and connected to, the handle 80 at one end thereof, and holding the work member 10 at an opposite end thereof. A sleeve 60 is positioned externally around the extension of the shaft 30 from the handle 80 and is connected to an outer sleeve 50 at a first end thereof. When one of the heads 26, 28 of the work member 10 of the tool 5 is located in a working position, the outer sleeve 50 is positioned physically against the handle 80, and the work member 10 is received within the sleeve bore 67 such that one of the ends 26, 28, extends outwardly from and through the sleeve bore 67.

Referring still to FIG. 4, the shaft 30 is comprised of a rectangular, box like base 31, having a shank 36 ending in a pair of arms 35a, b which extends from the base 31 in a first direction, and a threaded shaft connector 40 extending from an opposite end thereof. The shaft connector 40 connects the shaft 30 to the handle 80. One means of connection between the shaft 30 and handle 80, as depicted in FIG. 4, is a threaded connection. However, the shaft 30 could be connected to the handle 80 by other means as well (for example, a friction fit).

The arms 35a, b are formed by providing a gap 11 though the body of the shaft, such that generally flat, planer inner faces of each arm 35a, b face one another in a generally parallel relationship. A bias member track 32 extends along the shank 36 from a position on the shaft 30, adjacent to but spaced from the base 31 and terminates at a location wherein gap 11 begins, such that the distance between pin bores 33a, b and the end of the bias member track 32 is at least longer than the length of one half the work member 10 which allows the work member 10 to freely rotate about the pin 20 in the gap 11 without interfering engagement with the bias member track 32.

The bias member track 32 forms a recess in the outer circumference of the shaft 30 within which a biasing member 70, which is held between the sleeve 60 and an outer sleeve 50 via a biasing member fastener 72, bears against the track 32 in a compressed state when the work member 10 of the tool 5 is in one of its working positions. When a user of the tool 5 desires to switch the head of the work member 10 and moves the sleeve 60 away from the handle 80 to do so, the bias member track 32 also serves to guide the biasing member 70 along the shank 36 of the shaft 30 until the free end of the biasing member 70 extends beyond the end of the track 32 and thus engages the stored end of the work member 10 to rotate the work member 10 about the pin 20, as will be described further herein.

A narrow through shaped inlet 34 extends from approximately the middle of the base 31 of the shaft 30 between two of its opposing vertical faces and continues, generally co-linearly with the longitudinal axis of the shank 36 portion of the shaft 30 through the center of the bias member track 32 and terminates short of the end thereof. The inlet 34 is thinner than the width of the biasing member 70, but sufficiently wide enough that the biasing member fastener 72 may extend into the slot 34. When the sleeve 60 is moved away from the handle 80, and the biasing member fastener 72 reaches the end of the inlet 34 located in the bias member track 32, the biasing member fastener 72 and inlet 34 cooperate to prevent the sleeve 60 from moving further away from the handle 80 and thus become disengaged from the tool 5, and positions the longitudinal slots 65A, B in a position to enable the end of the work member to pass through slot 65A. When the sleeve 60 is positioned with the fastener 72 at this end of the inlet 34, the sleeve 60 is at its furthest distance away from the handle 80. Accordingly, the length 34a of the inlet 34 is at least long enough to position the clearance slots 65A, B of the sleeve 60 such that both ends of the work member 10 may freely pass through the clearance slots 65A, B when the sleeve 60 is at its furthest distance away from the handle 80, the shorter of the two slots, slot 65A, defining the proper position of the sleeve 30 in this extended position.

The arms 35a, b of the shaft 30 receive and support the work member 10 there between. The arms 35a, b extend, from the base 31 of the shaft 30 and are spaced apart so that the gap 11 between the arms 35a, b is wider than the width of the work member 10 across opposed flats thereof, to permit rotation of the work member in the gap 11 formed between the two arms 35a, b. The work member 10 is supported between the arms 35a, b on the pin 20, which extends through, and is secured within (such as by a press fit), the work member pin bore 22 positioned through the work member's 10 midsection, and is received, at opposite ends thereof, in arm bores 33a, 33b extending inwardly and through the opposed faces of the arms 35a, b. The pin bore 22 is positioned approximately midway between the terminuses of the two heads 26, 28 of the work member; such that the heads 26, 28 may be pivoted about the pin 20 to selectively position one of the heads 26, 28 through the sleeve bore 67. Alternate embodiments could include other fastening means permitting the work member 10 to rotate between the shaft arms 35.

The work member 10 consists of two heads 26, 28, one at either end of the work member 10. The two heads are preferably different, allowing the tool 5 to serve multiple functions. In the exemplary embodiment shown, the first head 26 of the work member 10 is a Phillips head screwdriver tip and the second head 28 is a flat head screwdriver tip. This is not meant to limit the types of tool heads, and is merely illustrative of one type of work member 10 that could be used in the present tool 5. However, it will be understood that the heads could form any number of head types depending on the needs of a user. For example, the heads could be socket type tools, Allen wrenches, or even screwdriver like tools of different sizes. Any combination of head types are interpreted to be within the scope of the invention so long as they can be located at each end of the work member 10 and are sized to ensure that the heads can pass through the gap 11 between the opposed arms 35a, b of the inner shaft for purposes of interchanging the positions of the heads 26, 28.

To enable automated interchanging of the head 26, 28 positions, the sleeve 60, and biasing member 70, is position able over the shaft 30. The sleeve 60 is configured to provide anti-rotational (in the longitudinal direction of the shaft 30) support to the work member 10 when the work member 10 is positioned for tool use, and to selectively position the biasing member 70 to cause pivoting of the work member about the pin 20 during the interchange of the two heads 26, 28 of the work member 10. In this regard, the sleeve 60 is a generally hollow, cylindrical tube which is sized and configured to be slidingly received over the shaft 30, and it includes, two longitudinal clearance slots 65A, 65B formed on opposing sides thereof. At the end of the sleeve 60 that receives the work member 60, a sleeve bore 67 having a mating cross section of the work member 10 is provided to receive the work member therethrough, in order to prevent rotation of the work member 10 within the sleeve 60 when the work member 10 in a working position 100, 200. The shaft 30 is concentrically disposed within the hollow interior of the sleeve 60.

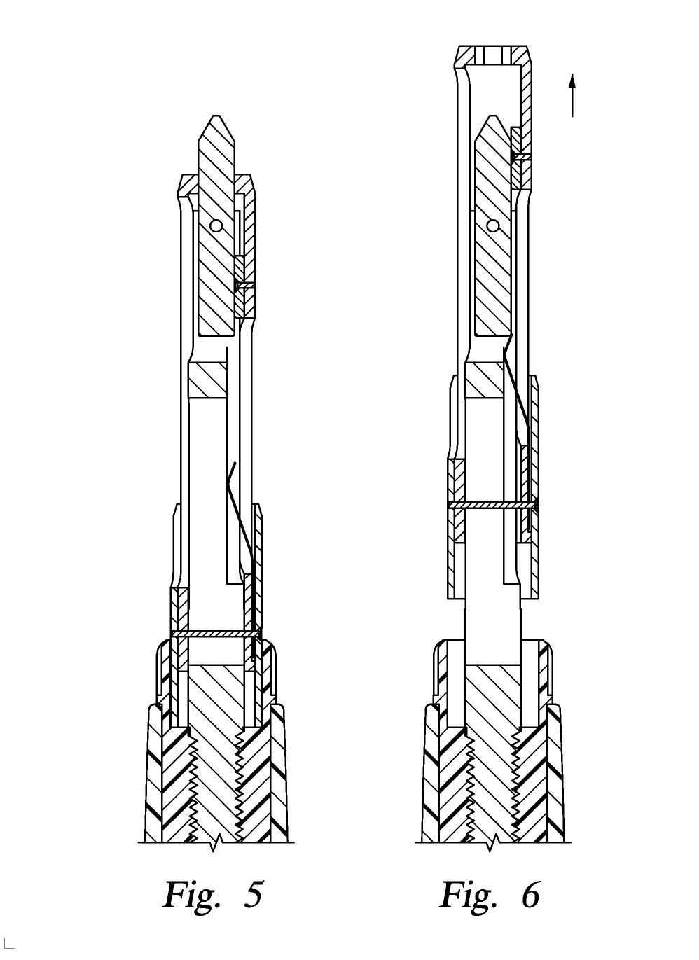

Referring now to FIG. 5, the clearance slots 65A, 65B are formed on either side of the sleeve 60 to permit portions of the work member 10 to pass therethrough when the work member 10 is rotated about the pin 20 to interchange the position of heads 26, 28. (See FIGS. 8-10). One of the clearance slots 65B has a longer opening than the other clearance slot 65A. The clearance slot 65A with the shorter opening includes a shim 62 located inwardly and axially spaced from an upper end of the slot 65A. The shim 62 is attached to the inside of the sleeve 65 by means of a shim fastener 64, such as a set screw. The thickness of the shim 62 aligns the inward face thereof generally co-planar with one or more of the facets of the sleeve bore 67. Thus, when the sleeve 60 moves from the working position of the tool 5 of FIG. 5 to the position of FIG. 6, at least one facet of the work member 10 is engaged on, and may slide upon, the shim 62, such that the biasing member 70 is positioned against and may slide upon the same facet of work member 10, at the opposite end thereof, when the work member is in contact with shim 32. In an alternate embodiment, the shim 62 is not a separate component but simply an integrated feature of the sleeve 60.

The biasing member 70 is placed externally on the sleeve 60 immediately below the clearance slot 65A with the shorter opening. The biasing member 70 is secured between the sleeve 60 and an outer sleeve 50. The biasing member 70, such as a leaf or bias spring, is a flexible, preferably metallic, material and is capable of deforming such that one end of the biasing member 70 can remain in a compressed state while on the bias member track 32. When the biasing member 70 is positioned on the bias member track 32, the free end 71 of the biasing member 70 is angled away from the bias member track 32. The angle between the free end 71 of the biasing member 70 and the bias member track 32 enables the biasing member 70 to engage the work member 10 from its side nearest clearance slot 65A when the biasing member 70 engages the work member 10, which occurs when the biasing member 72 is still positioned on the bias member track 32 and when the work member 10 is still in a vertical position within the sleeve 60. Accordingly, when the biasing member 70 has fully traversed the biasing track 32, which occurs when the sleeve 60 moves axially away from the handle 80, the free end 71 of the biasing member 70 engages the (vertical) work member 10 on its side, which ensures that the bias member 70 will be guided over the shank of the work member 10, and not contact against the end of the tool member 10 stored within the gap 11. As the sleeve 60 continues to move axially away from the handle 80, the biasing member 70 may decompress to its free state as it engages the side of the work member 10, and thereby spin or rotate the work member 10 about the pin 20 and through the clearance slots 65A, B in the sleeve 60.

The outer sleeve 50, as discussed above, is attached to the sleeve 60 by means of a biasing member fastener 72, which serves to fasten both the outer sleeve 50 and biasing member 70 to the sleeve 60. The outer sleeve 50, in one embodiment (not shown), can have an external and internal diameter that is equal to or slightly wider than the external diameter of the handle 80, wherein the outer sleeve 50 sits over an outer sleeve rest 82 of the handle. In this configuration, a friction fit may prevent movement of the sleeve 60 and outer sleeve 50 relative to the handle 80. In yet another embodiment, shown in FIGS. 5-10, the outer sleeve 50 has an external diameter that fits within a counterbore 87 of the handle 80. The external diameter of the outer sleeve 50 may provide a friction fit within the counterbore 87 so that movement in any direction (axially or rotationally) of the sleeve 60 and outer sleeve 50 is limited when the work member 10 is in one of its working positions 100, 200. In yet another embodiment, the outer sleeve 50 is not locked to the handle 80 when the work member 10 is in one of its working positions 100, 200, and instead, stays in place due to the friction between the biasing member 72 and the bias member track 32 resisting axial movement relative to the shaft 30.

The handle 80 of the quick change tool 5 includes a threaded bore 85 at one end to receive the shaft connector 40. On the same end of the handle 80, a wider counterbore 87 is present to receive the outer sleeve 50, as discussed above. Alternatively to the counterbore 87 configuration, the external portion of the handle 80 is formed into an outer sleeve rest 82. The outer sleeve rest 82 could consist of multiple grooves such that an outer sleeve 50 can temporarily lock into the handle 80 by means of a friction fit. However, the outer sleeve rest 82 could consist of any means (or no means) to temporarily fix an outer sleeve 50 to the handle 80. In yet a different embodiment, the shaft 30 of the tool 5 and the handle 80 could be integrated into a unitary component.

FIGS. 5-10 are cutaway views of the tool 5 that illustrate step-by-step positioning of the components as the work member 10 moves from the first working position 100 to the second working position 200, and therefore interchanging the first head 26 and the second head 28. FIG. 5 is a cutaway view of the tool 5 in the first working position 100, wherein a first head 26 of the tool 5 is positioned for use by a tool user. In this position, the outer sleeve 50 is positioned within the counterbore 87 of the handle 80, the biasing member 70 is in its compressed state on the bias member track 32 of the shaft 30, the work member 10 is vertically positioned within the sleeve 60 with the first head 26 extended through the sleeve bore 67. In this position, the first head 26 of the tool 5 can be used.

FIG. 6 is a cutaway view of the tool 5 wherein the outer sleeve 50 is positioned a first distance from the handle 80 such that the biasing member 70 engages the side of the shaft of the work member 10 internally of sleeve 60 in eth storage position of one of the heads therein. The outer sleeve 50 has moved axially away from the handle 80 which has in turn caused the biasing member 70 to move along the bias member track 32 of the shaft 30. As illustrated, the shim 62 operates to maintain the vertical position of the work member 10 within the sleeve 60, even though the work member 10 is partially retracted in the sleeve 60. In the position shown, the biasing member 70 is in contact with the end of the work member 10.

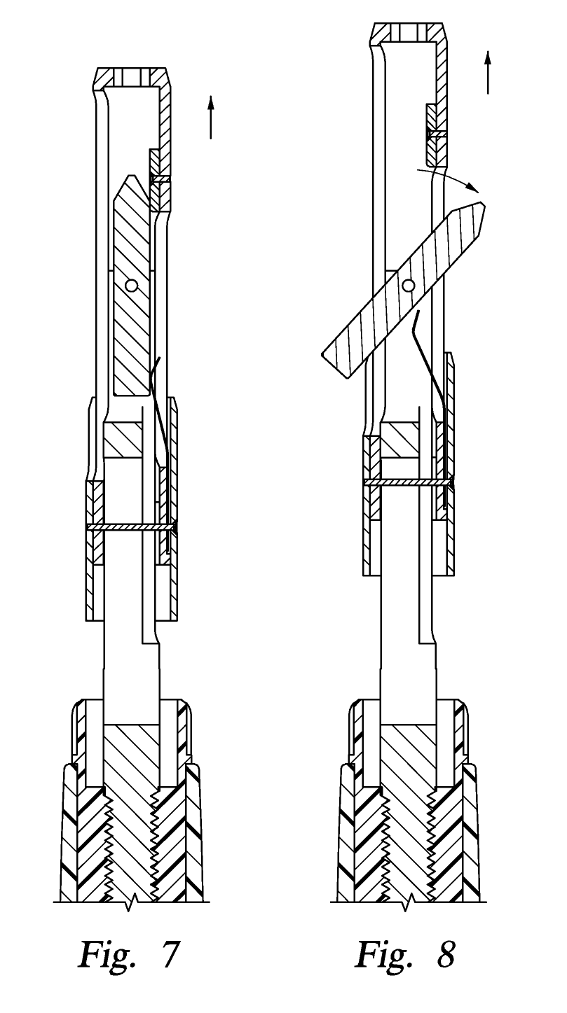

FIG. 7 is a cutaway view of the tool 5, wherein the outer sleeve 50 is positioned a second distance from the handle of the tool 5 such that the work member 10 can rotate through the clearance slots 65A, B in the sleeve 60. In FIG. 7, the shim 62 on sleeve 60 has cleared off of the work member 10 and the work member 10 has rotated through the clearance slots 65A, B due to the released energy of the biasing member 70 as it moves from its compressed state on the track 62 to a compressed state. The free end 71 of the biasing member 70 has moved partially through the gap 11 in the shaft of the sleeve 60, and has continued to guide the rotation of the work member 10 through the clearance slots 65A, B and between the inner shaft arms 35a, b (shown in FIG. 4).

FIG. 8 is a cutaway view of the tool 5 wherein the sleeve 60 is positioned at its furthest extension from the handle 80 and the biasing member 70 has caused the work member 10 to rotate through the sleeve 50. The free end 71 of biasing member 70 has moved fully through the gap 11, and the second head 28 of the work member 10 has rotated about pin 20 and is now positioned extending outwardly of slot 65B in sleeve 60. At this sleeve 60 position, the biasing member fastener 72 has reached the end of the inlet 34 in the bias member track 32. The biasing member 70 need only supply or store sufficient energy to cause the end of the work member 10, which has been retracted from bore 67 in sleeve 60, to be positioned outwardly of slot 65A when sleeve 60 is moved from the position shown in FIG. 5 to the position shown in FIG. 8. Thereafter, retraction of the sleeve 60 toward the end of the handle 80 will cause the end of the slot 65A to guide the work member 10 to position the opposed end thereof into alignment for receipt in bore 67 of the sleeve 60.

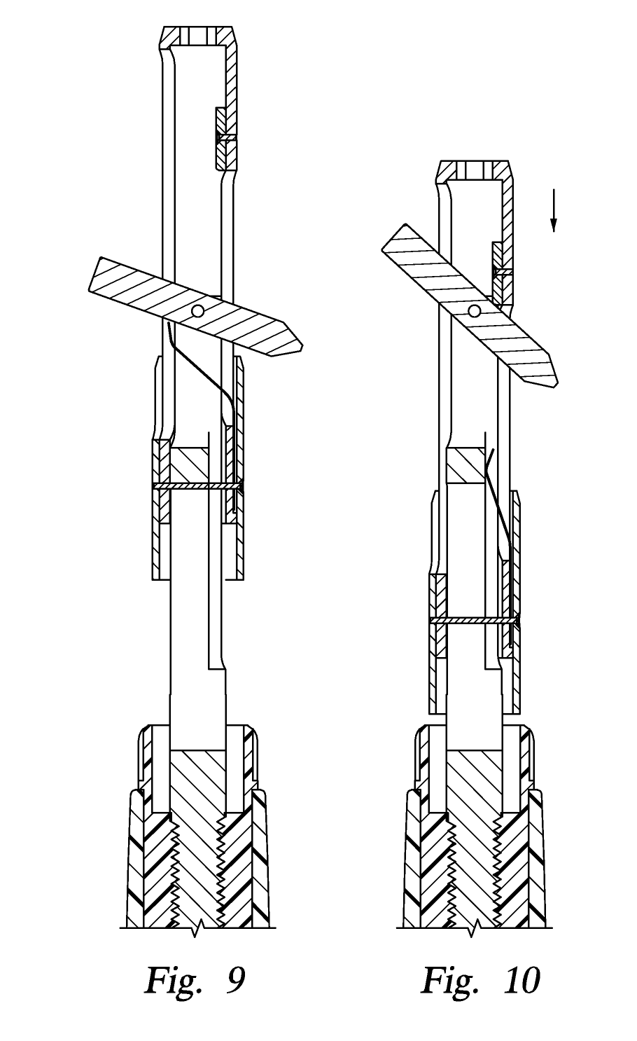

FIG. 9 shows a cutaway view of the tool 5 wherein the sleeve 60 has been moved axially toward the handle 80 from the sleeve position of FIG. 8 such that a shim 62 has made contact against the work member 10. As the sleeve 60 continues to move back toward the handle, the shim 62 will continue moving the work member 10 by sliding along the shank of the work member 10 and rotate the work member 10 on pin 20, which in turn moves the second head 28 toward the working position, and through the clearance slot 65B. Simultaneously, as the biasing member 70 is moved along the shaft 30 in the direction of the handle 80, it becomes re-positioned back onto the biasing track 32. In this position, the biasing member 70 will not interfere with the rotation of the work member 10, and bias member 70 becomes recompressed to re store the energy needed to move the work member on the pin 20.

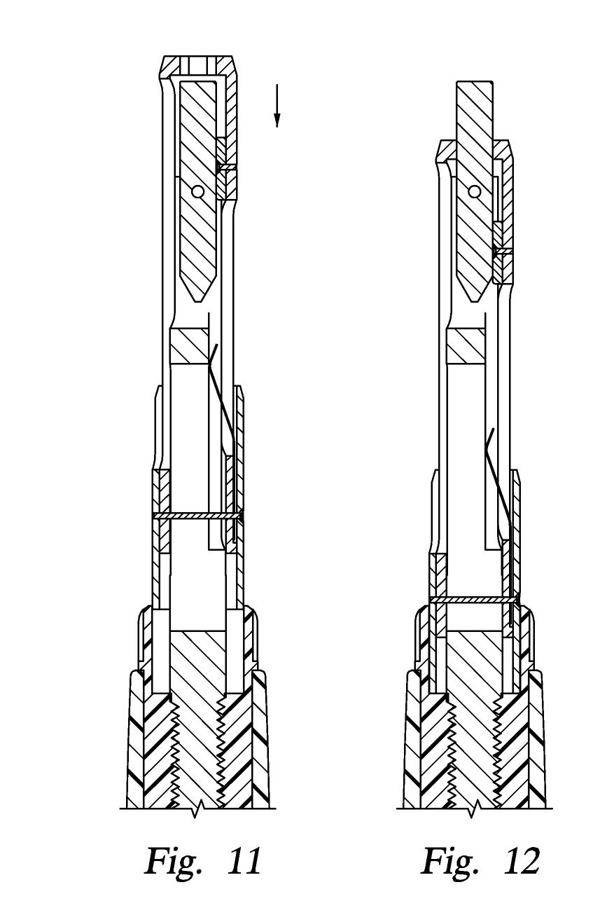

FIG. 10 shows a cutaway view of the tool 5 wherein the outer sleeve 50 has been repositioned back on the handle 80, and the second head 28 of the work member 10 has been received through the sleeve bore 67 and thus the work member 10 is in the second working position 200. Here, the tool user has completed the process of changing from the first head 26 to the second head 28 of the work member 10. In this second working position 200, the second head 28 of the tool 5 may be used.

In summary, the disclosed tool 5 offers the ability for a user to use different heads 26, 28 within one hand tool, which heads are quickly and easily interchanged. Simply stated, to interchange the tool heads, a user need only move the sleeve 60 of the tool 5 axially away from the handle 80 and then back into place on the handle 80.

While the foregoing is directed to embodiments of the present invention, other and further embodiments of the invention may be devised without departing from the basic scope thereof, and the scope thereof is determined by the claims that follow.

1. A tool, comprising:
a work member having at least two working surfaces, said work member rotatably coupled to a shaft; and
a sleeve axially movable relative to the shaft, wherein axial movement of the sleeve causes a biasing member moveable with respect to said shaft by motion of said sleeve with respect to said shaft to engage the work member to rotate the work member on said sleeve to position different working surfaces of said work member at a first working position of the tool.

2. The tool of claim 1, wherein the biasing member extends from the sleeve and into contact with the shaft and is operable to resist axial movement of the sleeve relative to the shaft.

3. The tool of claim 1, wherein movement of the sleeve in a first axial direction moves the biasing member into engagement with the work member to initiate rotation of the work member with respect to the shaft.

4. The tool of claim 3, wherein movement of the sleeve in a second axial direction moves the sleeve into engagement with the work member to position the work member into alignment with a longitudinal axis of the sleeve.

5. The tool of claim 1, wherein the sleeve includes a clearance slot disposed through the sleeve, and wherein at least a portion of the work member may pass through the clearance slot during movement of the sleeve with respect to the shaft.

6. The tool of claim 1, wherein the sleeve includes a bore disposed through an end of the sleeve, wherein the work member may be disposed through the bore when in alignment with the longitudinal axis of the sleeve.

7. The tool of claim 1, wherein the work member is coupled, on a shaft, to a pair of arms that form an end of the shaft.

8. The tool of claim 1, wherein the work member includes a first and a second head operable for use the working position.

9. A tool, comprising:
a shaft;
a sleeve axially movable relative to the shaft;
a biasing member coupled to the sleeve; and
a work member rotatably coupled to the shaft, wherein movement of the sleeve in a first direction moves the biasing member into engagement with the work member to rotate the work member, and wherein movement of the sleeve in a second, opposite direction moves the sleeve into engagement with the work member to rotate the work member into alignment with a longitudinal axis of the sleeve.

10. The tool of claim 10, wherein the shaft is concentrically disposed within the sleeve.

11. A method of operating a tool, comprising:
moving a sleeve in a first axial direction relative to a shaft to move a work member that is coupled to the shaft from a first working position; and
moving the sleeve in a second axial direction relative to the shaft to move the work member into a second working position.

12. The method of claim 11, further comprising moving a biasing member that is coupled to the sleeve into engagement with the work member to move the work member from the first working position.

13. The method of claim 12, wherein the biasing member engages the work member to move the work member into the second working position.

14. The method of claim 11, wherein the work member is moved from the first working position to the second working position solely by using axial movement of the sleeve.

15. The method of claim 11, wherein the work member includes a work member operable for use in the first working position, and a work member operable for use in the second working position.

16. The method of claim 11, wherein the work member is rotatable within a gap disposed through the shaft.

17. The method of claim 11, wherein the work member is rotatable within clearance slots disposed through the sleeve.

18. The method of claim 11, wherein the shaft is concentrically disposed within the sleeve.

19. The method of claim 11, wherein the work member extends from an end of the sleeve when in the first and second working positions.

20. The method of claim 11, wherein the sleeve moves the work member into alignment with a longitudinal axis of the sleeve.
